(19) United States
(12) Patent Application Publication
(10) Pub. No.: US 2025/0182496 A1
(43) Pub. Date: Jun. 5, 2025

(54) APPARATUS FOR RECOGNIZING OBJECT AND METHOD THEREOF

(71) Applicants: Hyundai Motor Company, Seoul (KR); Kia Corporation, Seoul (KR)

(72) Inventor: Nam Hyung Lee, Hwaseong-si (KR)

(21) Appl. No.: 18/771,336

(22) Filed: Jul. 12, 2024

(30) Foreign Application Priority Data
Nov. 30, 2023 (KR) 10-2023-0171454

(51) Int. Cl. G06V 20/58; G06V 20/56

(52) U.S. Cl. CPC G06V 20/58; G06V 20/588

(57) ABSTRACT

An embodiment object recognition apparatus includes a LIDAR, one or more processors, and a non-transitory storage storing a program to be executed by the one or more processors and including instructions to determine left and right lines located on left and right sides of a host lane, determine a first straight line based on a first reference point included in an object box and the left line, a second straight line based on the first reference point and the right line, a third straight line based on the first and second straight lines and representing a middle line of the host lane, or any combination thereof, and determine a state corresponding to a position of the object with respect to the host lane based on a relative positional relationship between one or more of the first, second, and third straight lines and a second reference point representing a position of the object box.

### CROSS-REFERENCE TO RELATED APPLICATIONS

This application claims the benefit of Korean Patent Application No. 10-2023-0171454, filed on Nov. 30, 2023, which application is hereby incorporated herein by reference.

### TECHNICAL FIELD

The present disclosure relates to an object recognition apparatus and method.

### BACKGROUND

Technology to detect surrounding environments and avoid obstacles is essential for autonomous vehicles.

A vehicle may obtain data indicating the position of an object around the vehicle through a light detection and ranging (LIDAR). A distance from a LIDAR to an object may be obtained through an interval between the time when a laser light is transmitted by the LIDAR and the time when the laser light reflected by the object is received. A vehicle is able to determine the location of a point included in the object in a space where the vehicle is located, based on the angle of the transmitted laser light and the distance to the object.

Data obtained through the LIDAR is characterized by high resolution and a large number of points included in the data. The importance of technology for determining objects around vehicles from the data is increasing.

### SUMMARY

The present disclosure relates to an object recognition apparatus and method. Particular embodiments relate to a technique for determining a position of an object with respect to a host lane based on a contour point obtained through a LIDAR.

Embodiments of the present disclosure can solve problems occurring in the prior art while advantages achieved by the prior art are maintained intact.

An embodiment of the present disclosure provides an object recognition apparatus and method for improving the accuracy of the position of an object with respect to a host lane when the host lane is a curved path.

An embodiment of the present disclosure provides an object recognition apparatus and method for improving the accuracy of the position of an object with respect to a host lane at a distance.

An embodiment of the present disclosure provides an object recognition apparatus and method for determining the position of an object through LIDAR points.

An embodiment of the present disclosure provides an object recognition apparatus and method for reducing the risk of accidents by improving the accuracy of the position of an object with respect to a host lane.

An embodiment of the present disclosure provides an object recognition apparatus and method for improving the comfort of vehicle operation by improving the accuracy of the position of an object with respect to a host lane.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, an object recognition apparatus may include a LIDAR and one or more processors, and a non-transitory storage storing a program to be executed by the one or more processors.

According to an embodiment, the program may include instructions to determine a left line located on a left side of a host lane and a right line located on a right side of the host lane, determine a first straight line obtained based on a first reference point included in an object box and the left line, a second straight line obtained based on the first reference point and the right line, a third straight line obtained based on the first straight line and the second straight line and representing a middle line of the host lane, or any combination thereof, and determine a state corresponding to a position of the object with respect to the host lane based on a relative positional relationship between the first straight line, the second straight line, the third straight line, or any combination thereof and a second reference point representing a position of the object box. The host lane may be a lane where a host vehicle is located and includes a curved path. The object box may be a virtual box representing an object that is external to the host vehicle. The second reference point may be identical to or different from the first reference point.

According to an embodiment, the program further may include instructions to determine a first function representing the left line and a second function representing the right line, based on the first reference point, the first function, the second function, and a specified distance, determine a first point and a second point located on the left line, determine a third point and a fourth point located on the right line, determine a fifth point that is a middle point between the first point and one point among the third point and the fourth point whose longitudinal coordinate matches a longitudinal coordinate of the first point, determine a sixth point that is a middle point between the second point and one point among the third point and the fourth point whose longitudinal coordinate matches a longitudinal coordinate of the second point, and determine the state corresponding to the position of the object with respect to the host lane based on the first straight line connecting the first point and the second point, the second straight line connecting the third point and the fourth point, the third straight line connecting the fifth point and the sixth point, and the second reference point. The fifth point may be located on a line segment connecting the first point and the one of the third point and the fourth point whose longitudinal coordinate matches the longitudinal coordinate of the first point. Wherein the sixth point is located on a line segment connecting the second point and the one of the third point and the fourth point whose longitudinal coordinate matches the longitudinal coordinate of the second point.

According to an embodiment, the coordinates of the first point may include a longitudinal coordinate of the first reference point and a lateral coordinate obtained by substituting the first reference point into the first function. The coordinates of the second point may include a longitudinal coordinate of a point spaced apart longitudinally by the specified distance from the coordinate of the first reference point and a lateral coordinate obtained by substituting the longitudinal coordinate of the spaced point into the first function. The coordinates of the third point may include the longitudinal coordinate of the first reference point and a lateral coordinate obtained by substituting the first reference point into the second function, and the coordinates of the fourth point may include the longitudinal coordinate of the spaced point and a lateral coordinate obtained by substituting the longitudinal coordinate of the spaced point into the second function.

According to an embodiment, the program further may include instructions to determine the first function and the second function in a form of an N-th order function.

According to an embodiment, the program further may include instructions to determine the first function, the second function, or the first function and the second function based on a portion of an image identified through a camera, or determine the first function, the second function, or the first function and the second function based on a yaw rate of the host vehicle, a steering angle sensor angle, or the yaw rate of the host vehicle and the steering angle sensor angle.

According to an embodiment, the program further may include instructions to determine a first straight line function, which is a function representing the first straight line, a second straight line function, which is a function representing the second straight line, and a third straight line function, which is a function representing the third straight line, determine a first area where the object is located among a left area and a right area separated by the left line based on a sign of a value obtained by substituting coordinates of the second reference point into the first straight line function, determine a second area where the object is located among the left area and the right area separated by the right line based on the sign of the value obtained by substituting the coordinates of the second reference point into the second straight line function, determine a third area where the object is located among the left area and the right area separated by the middle line based on the sign of the value obtained by substituting the coordinates of the second reference point into the third straight line function, and determine a state corresponding to the position of the object based on the first area, the second area, the third area, or any combination of the first area, the second area, and the third area.

According to an embodiment, the program further may include instructions to determine the state corresponding to the position of the object as a first state based on the second reference point being located in a left area with respect to the left line and the second reference point being located in the left area with respect to the right line, determine the state corresponding to the position of the object as a second state based on the second reference point being located in a right area with respect to the left line, the second reference point being located in the left area with respect to the right line, and the second reference point being located in the left area with respect to the middle line, determine the state corresponding to the position of the object as a third state based on the second reference point being located in the right area with respect to the left line, the second reference point being located in the left area with respect to the right line, and the second reference point being located in the right area with respect to the middle line, and determine the state corresponding to the position of the object as a fourth state based on the second reference point being located in the right area with respect to the left line and the second reference point being located in the right area with respect to the right line.

According to an embodiment, the first state may indicate that the object is located in the left area outside the host lane. The second state may indicate that the object is located in the left area within the host lane. The third state may indicate that the object is located in the right area within the host lane, and the fourth state may indicate that the object is located in the right area outside the host lane.

According to an embodiment, the program further may include instructions to determine the first reference point including a center point of a side closest to the host vehicle among four sides defining the object box, and determine the second reference point including a center point of the object box.

According to an embodiment, the recognition apparatus further may include a camera and a radar. The program further may include instructions to determine the first reference point and the second reference point based on the object identified through the LIDAR, the radar, the camera, or any combination of the LIDAR, the radar, and the camera.

According to an embodiment of the present disclosure, an object recognition method may include determining a left line located on a left side of a host lane and a right line located on a right side of the host lane, determining a first straight line obtained based on a first reference point included in an object box and the left line, a second straight line obtained based on the first reference point and the right line, a third straight line obtained based on the first straight line and the second straight line and representing a middle line of the host lane, or any combination thereof, and determining a state corresponding to a position of the object with respect to the host lane based on a relative positional relationship between the first straight line, the second straight line, the third straight line, or any combination thereof and a second reference point representing a position of the object box. The host lane may be a lane where a host vehicle is located and includes a curved path. The object box may be a virtual box representing an object that is external to the host vehicle. The second reference point may be identical to or different from the first reference point.

According to an embodiment, the determining the left line located on the left side of the host lane and the right line located on the right side of the host lane comprises determining a first function representing the left line and a second function representing the right line, and determining the first straight line obtained based on the first reference point included in the object box and the left line, the second straight line obtained based on the first reference point and the right line, the third straight line obtained based on the first straight line and the second straight line and representing the middle line of the host lane, or any combination thereof may include determining a first point and a second point located on the left line based on the first reference point, the first function, the second function, and a specified distance, determining a third point and a fourth point located on the right line, determining a fifth point that is a middle point between the first point and one point among the third point and the fourth point whose longitudinal coordinate matches a longitudinal coordinate of the first point, and determining a sixth point that is a middle point between the second point and one point among the third point and the fourth point whose longitudinal coordinate matches a longitudinal coordinate of the second point, and determining the state corresponding to the position of the object with respect to the host lane based on the relative positional relationship between the first straight line, the second straight line, the third straight line, or any combination thereof and the second reference point representing the position of the object box comprises determining the state corresponding to the position of the object with respect to the host lane based on the first straight line connecting the first point and the second point, the second straight line connecting the third point and the fourth point, the third straight line connecting the fifth point and the sixth point, and the second reference point. The fifth point may be located on a line segment connecting the first point and the one of the third point and the fourth point whose longitudinal coordinate matches the longitudinal coordinate of the first point. The sixth point may be located on a line segment connecting the second point and the one of the third point and the fourth point whose longitudinal coordinate matches the longitudinal coordinate of the second point.

According to an embodiment, the coordinates of the first point may include a longitudinal coordinate of the first reference point and a lateral coordinate obtained by substituting the first reference point into the first function. The coordinates of the second point may include a longitudinal coordinate of a point spaced apart longitudinally by the specified distance from the coordinate of the first reference point and a lateral coordinate obtained by substituting the longitudinal coordinate of the spaced point into the first function. The coordinates of the third point may include the longitudinal coordinate of the first reference point and a lateral coordinate obtained by substituting the first reference point into the second function. And the coordinates of the fourth point may include the longitudinal coordinate of the spaced point and a lateral coordinate obtained by substituting the longitudinal coordinate of the spaced point into the second function.

According to an embodiment, the determining the left line located on the left side of the host lane and the right line located on the right side of the host lane may include determining the first function and the second function in a form of an N-th order function.

According to an embodiment, the determining the first function representing the left line and the second function representing the right line may include determining the first function, the second function, or the first function and the second function based on a portion of an image identified through a camera, or determining the first function, the second function, or the first function and the second function based on a yaw rate of the host vehicle, a steering angle sensor angle, or the yaw rate of the host vehicle and the steering angle sensor angle.

According to an embodiment, the determining the state corresponding to the position of the object with respect to the host lane based on the relative positional relationship between the first straight line, the second straight line, the third straight line, or any combination thereof and the second reference point may include determining a first straight line function, which is a function representing the first straight line, a second straight line function, which is a function representing the second straight line, and a third straight line function, which is a function representing the third straight line, determining a first area where the object is located among a left area and a right area separated by the left line based on a sign of a value obtained by substituting coordinates of the second reference point into the first straight line function, determining a second area where the object is located among the left area and the right area separated by the right line based on the sign of the value obtained by substituting the coordinates of the second reference point into the second straight line function, determining a third area where the object is located among the left area and the right area separated by the middle line based on the sign of the value obtained by substituting the coordinates of the second reference point into the third straight line function, and determining a state corresponding to the position of the object based on the first area, the second area, the third area, or any combination of the first area, the second area, and the third area.

According to an embodiment, the determining the state corresponding to the position of the object with respect to the host lane based on the relative positional relationship between the first straight line, the second straight line, the third straight line, or any combination thereof and the second reference point may include determining the state corresponding to the position of the object as a first state based on the second reference point being located in a left area with respect to the left line and the second reference point being located in a left area with respect to the right line, determining the state corresponding to the position of the object as a second state based on the second reference point being located in a right area with respect to the left line, the second reference point being located in the left area with respect to the right line, and the second reference point being located in the left area with respect to the middle line, determining the state corresponding to the position of the object as a third state based on the second reference point being located in the right area with respect to the left line, the second reference point being located in the left area with respect to the right line, and the second reference point being located in the right area with respect to the middle line, and determining the state corresponding to the position of the object as a fourth state based on the second reference point being located in the right area with respect to the left line and the second reference point being located in the right area with respect to the right line.

According to an embodiment, the first state may indicate that the object is located in the left area outside the host lane. The second state may indicate that the object is located in the left area within the host lane. The third state may indicate that the object is located in the right area within the host lane. And the fourth state may indicate that the object is located in the right area outside the host lane.

According to an embodiment, the object recognition method may further include determining the first reference point including a center point of a side closest to the host vehicle among four sides defining the object box, and determining the second reference point including a center point of the object box.

According to an embodiment, the object recognition method may further include determining the first reference point and the second reference point based on the object identified through a LIDAR, a radar, a camera, or any combination of the LIDAR, the radar, and the camera.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram showing a configuration of an object recognition apparatus according to an embodiment of the present disclosure;

FIG. 2 illustrates a flow chart of operations of an object recognition apparatus for determining a state corresponding to the position of an object with respect to a host lane in an object recognition apparatus or method according to an embodiment of the present disclosure;

FIG. 3 illustrates examples of a determined left line and a determined right line in an object recognition apparatus or an object recognition method according to an embodiment of the present disclosure;

FIG. 4 illustrates examples of identification of a first straight line, a second straight line, and a third straight line in an object recognition apparatus or an object recognition method according to an embodiment of the present disclosure;

FIG. 5 illustrates examples of a state corresponding to the position of an object with respect to a host lane in an object recognition apparatus or an object recognition method according to an embodiment of the present disclosure;

FIG. 6 illustrates a table showing states corresponding to the position of an object with respect to a host lane in an object recognition apparatus or an object recognition method according to an embodiment of the present disclosure;

FIG. 7 illustrates a flow chart of operations of an object recognition apparatus for determining a state corresponding to the position of an object with respect to a host lane in an object recognition apparatus or method according to an embodiment of the present disclosure;

FIG. 8A illustrates an example of state identification according to an existing object recognition apparatus and FIG. 8B illustrates an example of state identification according to an object recognition apparatus in an object recognition apparatus or an object recognition method according to an embodiment of the present disclosure; and

FIG. 9 illustrates a computing system related to an object recognition apparatus and an object recognition method according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and they are not to be interpreted as having ideal or excessively formal meanings unless clearly defined as having such in the present application.

In addition, in the present disclosure, the expressions “greater than” or “less than” may be used to indicate whether a specific condition is satisfied or fulfilled, but they are used only to indicate examples and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

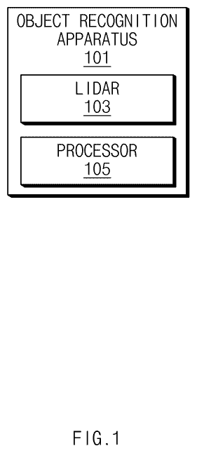

Hereinafter, embodiments of the present disclosure will be described in detail with reference to FIGS. 1 to 9.

FIG. 1 is a block diagram showing a configuration of an object recognition apparatus according to an embodiment of the present disclosure.

Referring to FIG. 1, an object recognition apparatus 101 may include a LIDAR 103 and a processor 105.

At least one of the LIDAR 103 or the processor 105 or any combination thereof may be electronically and/or operatively coupled with each other by an electronic component as a communication bus.

According to an embodiment, hereinafter, combining pieces of hardware operatively may mean a direct connection or an indirect connection between the pieces of hardware being established in a wired or wireless manner such that first hardware of the pieces of hardware is controlled by second hardware of the pieces of hardware. The type and/or number of hardware included in the object recognition apparatus 101 is not limited to that shown in FIG. 1. For example, the object recognition apparatus 101 may include only some of the hardware components shown in FIG. 1.

According to an embodiment, the processor 105 of the object recognition apparatus 101 may further include a camera, a LIDAR, a radar, a yaw rate sensor, and a steering angle sensor (SAS).

According to an embodiment, the processor 105 of the object recognition apparatus 101 may determine a host lane, which is a lane in which a host vehicle is located, and an object located outside the host vehicle based on at least one of the camera, the LIDAR, the radar, the yaw rate sensor, or the steering angle sensor (SAS), or an any combination thereof.

For example, the processor 105 of the object recognition apparatus 101 may determine the host lane, which is the lane in which the host vehicle is located, based on a part of an image identified through the camera, or it may determine the host lane based on at least one of the yaw rate or the SAS angle of the host vehicle, or any combination thereof.

For example, the processor 105 of the object recognition apparatus 101 may obtain position information of points of an object around the host vehicle through the LIDAR 103. The processor 105 of the object recognition apparatus 101 may acquire contour points representing the object through the LIDAR 103. The processor 105 of the object recognition apparatus 101 may determine an object box including the contour points.

For example, the contour points may be identified in each of layers formed based on the z-axis, among the x-axis, y-axis, and z-axis. For example, the contour points may be obtained based on representative points included in a point cloud in each of the layers formed on the z-axis among the x-axis, y-axis, and z-axis. For example, the representative points may include all or part of points located outside among a plurality of points included in the point cloud. For example, a point cloud may be obtained by performing clustering based on each of a plurality of points acquired by a LIDAR being identified within a specified distance.

According to an embodiment, the processor 105 of the object recognition apparatus 101 may determine a left line located on the left side of the host lane and a right line located on the right side of the host lane.

According to an embodiment, the processor 105 of the object recognition apparatus 101 may determine a state corresponding to the position of an object with respect to the host lane according to a first straight line representing the path of the left line at a position according to the longitudinal coordinate of the object, a second straight line representing the path of the right line at a position according to the longitudinal coordinate of the object, a third straight line representing the middle line of the host lane at a position according to the longitudinal coordinate of the object, and the relative position of the object.

According to an embodiment, the processor 105 of the object recognition apparatus 101 may determine a first straight line obtained based on a first reference point included in an object box, which is a virtual box representing the object, and the left line. According to an embodiment, the processor 105 of the object recognition apparatus 101 may determine a second straight line obtained based on the first reference point and the right line. According to an embodiment, the processor 105 of the object recognition apparatus 101 may determine a third straight line obtained based on the first reference point and the middle line of the host lane.

According to an embodiment, the processor 105 of the object recognition apparatus 101 may determine a state corresponding to the position of the object with respect to the host lane based on the relative positional relationship between at least one of the first straight line, the second straight line, or the third straight line, or any combination thereof and a second reference point representing the position of the object box. For example, the state of the object with respect to the host lane may include a first state indicating that the object is located in a left area outside the host lane, a second state indicating that the object is located in a left area within the host lane, a third state indicating that the object is located in a right area within the host lane, and a fourth state indicating that the object is located in a right area outside the host lane.

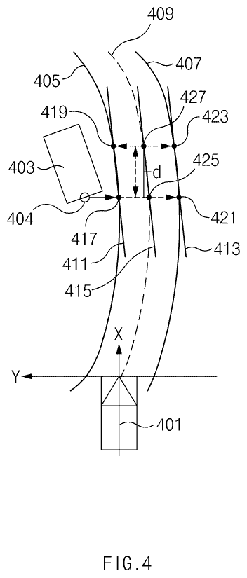

A method for determining the first straight line, the second straight line, and the third straight line will be described below with reference to FIG. 4.

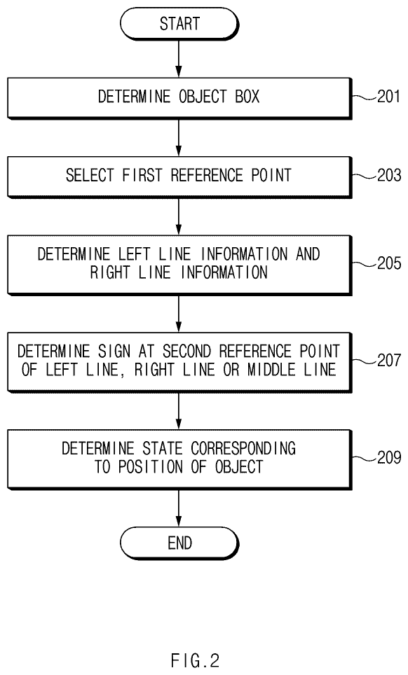

FIG. 2 illustrates a flow chart of operations of an object recognition apparatus for determining a state corresponding to the position of an object with respect to a host lane in an object recognition apparatus or method according to an embodiment of the present disclosure.

Hereinafter, it is assumed that the processor 105 of the object recognition apparatus 101 of FIG. 1 performs the process of FIG. 2. Additionally, in the description of FIG. 2, operations described as being performed by the object recognition apparatus may be understood as being controlled by the processor 105 of the object recognition apparatus 101.

Referring to FIG. 2, in a first operation 201, the processor of the object recognition apparatus may determine an object box. The processor of the object recognition apparatus may determine an object box based on a sensor (e.g., camera, LIDAR, or radar). An object box may include a virtual box to which information related to an object is assigned. For example, the object box may be referred to as a contour box.

In a second operation 203, the processor of the object recognition apparatus may select a first reference point. The first reference point may be included in the object box. For example, the first reference point may include the center point of a side closest to a host vehicle among four sides constituting the object box. The first reference point may be a reference point for determining the position of an object. An object may be referred to as a track, but embodiment of the present disclosure may not be limited thereto. The processor of the object recognition apparatus may determine a first reference point and a second reference point based on an object identified through at least one sensor selected from the group consisting of a LIDAR, a radar, and a camera.

In a third operation 205, the processor of the object recognition apparatus may determine left line information and right line information. The processor of the object recognition apparatus may determine left line information and right line information through at least one of a camera capturing the front of the host vehicle, a yaw rate sensor, or a steering angle sensor (SAS), or any combination thereof.

The left line information may include information on a first function representing a left line located on the left side of the host lane. The right line information may include information on a second function representing a right line located on the right side of the host lane.

In a fourth operation 207, the processor of the object recognition apparatus may determine a sign at a second reference point of the left line, the right line, or the middle line.

In other words, to determine the sign at the second reference point, the processor of the object recognition apparatus may determine a first straight line based on the first reference point and the first function representing the left line. The processor of the object recognition apparatus may determine a second straight line based on the first reference point and the second function representing the right line. The processor of the object recognition apparatus may determine a third straight line representing the middle line based on the first straight line and the second straight line.

The processor of the object recognition apparatus may determine the sign of a value determined by substituting the coordinates of the second reference point representing the position of the object box into a first straight line function representing the first straight line, a second straight line function representing the second straight line, or a third straight line function representing the third straight line. According to an embodiment, the second reference point may be identical to or different from the first reference point. According to an example, the second reference point may include the center point of the object box, but the embodiments of the present disclosure may not be limited thereto.

In a fifth operation 209, the processor of the object recognition apparatus may determine a state corresponding to the position of the object.

Based on the sign of the value determined by substituting the coordinates of the second reference point into a specific function (e.g., the first straight line function, the second straight line function, or the third straight line function), the processor of the object recognition apparatus may determine an area in which the object is located among the left and right areas separated by a line (e.g., the left line, the right line, or the middle line) corresponding to the specific function.

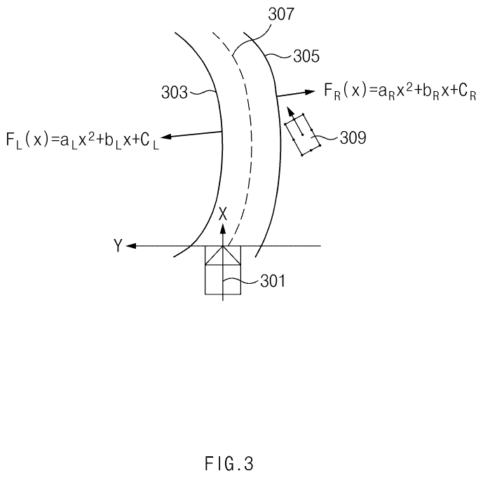

FIG. 3 illustrates examples of a determined left line and a determined right line in an object recognition apparatus or an object recognition method according to an embodiment of the present disclosure.

Referring to FIG. 3, a host vehicle 301 may be controlled by an object recognition apparatus. A left line 303, a right line 305, or a middle line 307 may be determined in the form of an N-order function (e.g., a quadratic function) by the object recognition apparatus. An object box 309 may represent an object for which a position with respect to a host lane is determined.

According to an embodiment, the object recognition apparatus may acquire parameters (e.g., a_{L}, b_{L}, c_{L}) representing the left line 303 and parameters (e.g., a_{R}, b_{R}, c_{R}) representing the right line 305. A parameter representing the middle line 307 may not be obtained by a sensor, but it may be determined by averaging values representing the positions of the left line 303 and the right line 305.

According to an embodiment, the middle line 307 may represent a midpoint between the left line 303 and the right line 305. The middle line 307 may be a reference for determining whether an object is biased to the right or left within the host lane.

According to an embodiment, the processor of the object recognition apparatus may determine a state corresponding to the position of the object with respect to the host lane based on the relative positional relationship between at least one of the left line 303, the right line 305, or the middle line 307, or any combination thereof and a second reference point representing the position of the object box 309. That is, the processor of the object recognition apparatus may determine the relative positional relationship between the host lane and a lane occupied by the object.

According to an embodiment, an object identified by a sensor or an autonomous driving system may mainly have a rectangular or cuboid shape. The object may appear in the form of the object box 309. A first reference point corresponding to one point of the object box 309 may be used to determine a first straight line and a second straight line according to the position of the object. A second reference point corresponding to another point of the object box 309 may be used to determine whether the object is located in the left or right area with respect to a specific straight line (e.g., a first straight line, a second straight line, or a third straight line). The first reference point and the second reference point may be identical to or different from each other.

FIG. 4 illustrates examples of identification of a first straight line, a second straight line, and a third straight line in an object recognition apparatus or an object recognition method according to an embodiment of the present disclosure.

Referring to FIG. 4, a host vehicle 401 may include an object recognition apparatus. A first point 417 and a second point 419 may be determined based on a first reference point 404, a specified distance (e.g., “d”), and a left line 405. A third point 421 and a fourth point 423 may be determined based on the first reference point 404, the specified distance, and the right line 407. A fifth point 425 may be determined based on the first point 417 and the third point 421. A sixth point 427 may be determined based on the second point 419 and the fourth point 423.

A first straight line 411 may be a straight line connecting the first point 417 and the second point 419. A second straight line 413 may be a straight line connecting the third point 421 and the fourth point 423. A third straight line 415 may be a straight line connecting the fifth point 425 and the sixth point 427. An object box 403 may represent the position of an object. The second reference point may be a reference for comparing the relative position of the object with the left line, the right line, or the middle line.

According to an embodiment, the processor of the object recognition apparatus may determine the first point 417, which is a point having a longitudinal coordinate of the first reference point 404 and a lateral coordinate determined by substituting the first reference point 404 into a first function representing the left line 405.

According to an embodiment, the processor of the object recognition apparatus may determine the second point 419, which is a point having a longitudinal coordinate of a point spaced apart from the longitudinal coordinate of the first reference point 404 by a specified distance (e.g., “d”) and a lateral coordinate determined by substituting the longitudinal coordinate of the spaced point into the first function representing the left line 405.

According to an embodiment, the processor of the object recognition apparatus may determine the third point 421, which is a point having the longitudinal coordinate of the first reference point 404 and a lateral coordinate determined by substituting the first reference point into a second function representing the right line 407.

According to an embodiment, the processor of the object recognition apparatus may determine the fourth point 423, which is a point having a longitudinal coordinate of a point longitudinally spaced apart from the longitudinal coordinate of the first reference point 404 by a specified distance (e.g., “d”) and a lateral coordinate determined by substituting the longitudinal coordinate of the spaced point into the second function representing the right line 407.

According to an embodiment, the processor of the object recognition apparatus may determine the fifth point 425, which is the middle point between one point (e.g., the third point 421) whose longitudinal coordinate matches the longitudinal coordinate of the first point 417 among the third point 421 and the fourth point 423, and the first point 417. The fifth point 425 may be located on a line segment connecting the first point 417 and the one point (e.g., the third point 421) whose longitudinal coordinate matches the longitudinal coordinate of the first point 417 among the third point 421 and the fourth point 423.

According to an embodiment, the processor of the object recognition apparatus may determine the sixth point 427, which is the middle point between one point (e.g., the fourth point 423) whose longitudinal coordinate matches the longitudinal coordinate of the second point 419 among the third point 421 and the fourth point 423, and the second point 419. The sixth point 427 may be located on a line segment connecting the second point 419 and the one point (e.g., the fourth point 423) whose longitudinal coordinate matches the longitudinal coordinate of the second point 419 among the third point 421 and the fourth point 423.

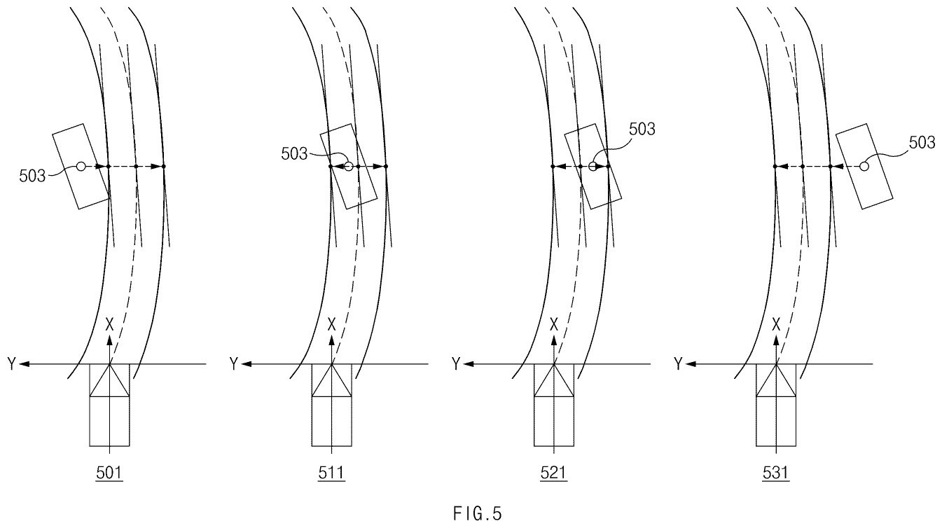

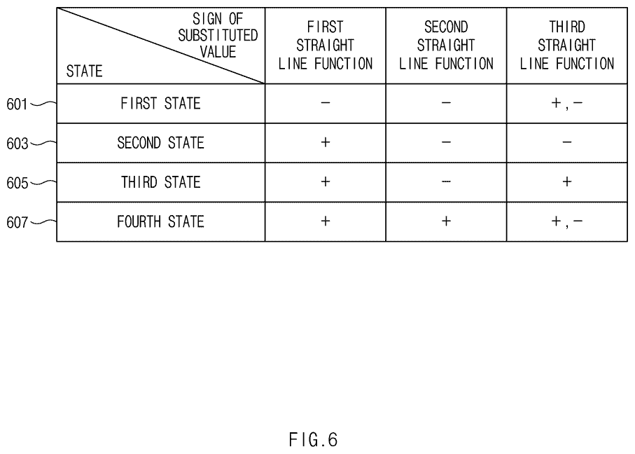

According to an embodiment, the processor of the object recognition apparatus may determine a state corresponding to the position of an object with respect to the host lane by comparing the positions of the first straight line, the second straight line, and the third straight line with a second reference point representing the position of the object (e.g., the center point of the object box 403). The state corresponding to the position of the object with respect to the host lane will be described with reference to FIGS. 5 and 6 below.

The longitudinal coordinate of the first reference point 404 may match the longitudinal coordinate of the first point 417, the longitudinal coordinate of the third point 421, and the longitudinal coordinate of the fifth point 425.

The longitudinal coordinate of the second point 419 may match the longitudinal coordinate of the fourth point 423 and the longitudinal coordinate of the sixth point 427. The longitudinal coordinate of the sixth point 427 may be the longitudinal coordinate of a point spaced apart longitudinally by a specified distance from the longitudinal coordinate of the fifth point 425. The longitudinal coordinate of the fifth point 425 may be an average value of the longitudinal coordinate of the first point 417 and the longitudinal coordinate of the third point 421. The longitudinal coordinate of the sixth point 427 may be an average value of the longitudinal coordinate of the second point 419 and the longitudinal coordinate of the fourth point 423.

The first straight line 411 may be expressed as Equation 1. a_{L} may denote a value obtained by subtracting the lateral coordinate of the first point 417 from the lateral coordinate of the second point 419. b_{L} may denote a value obtained by subtracting the longitudinal coordinate of the second point 419 from the longitudinal coordinate of the first point 417. c_{L} may denote a value obtained by subtracting the product of the longitudinal coordinate of the first point 417 and the lateral coordinate of the second point 419 from the product of the longitudinal coordinate of the second point 419 and the lateral coordinate of the first point 417.

$${F}_{L} ( x ) = {a}_{L} \cdot x + {b}_{L} \cdot y + {c}_{L} \qquad \underline{Equation 1}$$

The second straight line 413 may be expressed as Equation 2. a_{R} may denote a value obtained by subtracting the lateral coordinate of the third point 421 from the lateral coordinate of the fourth point 423. b_{R} may denote a value obtained by subtracting the longitudinal coordinate of the fourth point 423 from the longitudinal coordinate of the third point 421. c_{R} may denote a value obtained by subtracting the product of the longitudinal coordinate of the third point 421 and the lateral coordinate of the fourth point 423 from the product of the longitudinal coordinate of the fourth point 423 and the lateral coordinate of the third point 421.

$${F}_{R} ( x ) = {a}_{R} \cdot x + {b}_{R} \cdot y + {c}_{R} \qquad \underline{Equation 2}$$

The third straight line 415 may be expressed as Equation 3. a_{C} may denote a value obtained by subtracting the lateral coordinate of the fifth point 425 from the lateral coordinate of the sixth point 427. b_{C} may denote a value obtained by subtracting the longitudinal coordinate of the sixth point 427 from the longitudinal coordinate of the fifth point 425. c_{C} may denote a value obtained by subtracting the product of the longitudinal coordinate of the fifth point 425 and the lateral coordinate of the sixth point 427 from the product of the longitudinal coordinate of the sixth point 427 and the lateral coordinate of the fifth point 425.

$${F}_{C} ( x ) = {a}_{C} \cdot x + {b}_{C} \cdot y + {c}_{c} \qquad \underline{Equation 3}$$

FIG. 5 illustrates examples of a state corresponding to the position of an object with respect to a host lane in an object recognition apparatus or an object recognition method according to an embodiment of the present disclosure.

Referring to FIG. 5, a second reference point 503 may represent the position of an object and may be the center point of an object box. A first state 501 may indicate that the second reference point 503 is located in a left area outside the host lane. A second state 511 may indicate that the second reference point 503 is located in a left area within the host lane. A third state 521 may indicate that the second reference point 503 is located in a right area within the host lane. A fourth state 531 may indicate that the second reference point 503 is located in a right area outside the host lane.

According to an embodiment, the processor of the object recognition apparatus may acquire signs of values determined by substituting the longitudinal coordinate of the second reference point 503 into a first straight line function representing a first straight line, a second straight line function representing a second straight line, and a third straight line function representing a third straight line. The processor of the object recognition apparatus may determine a first area where an object is located relative to a left line, a second area where an object is located relative to a right line, and a third area where an object is located relative to a middle line according to the signs of the values determined by substituting the second reference point 503 into the straight line functions. Based on the combination of the first area, the second area, and the third area, the processor of the object recognition apparatus may determine a state (e.g., the first state 501, the second state 511, the third state 521, or the fourth state 531) corresponding to the position of the object relative to the host lane.

According to an embodiment, in the first state 501, the processor of the object recognition apparatus may determine that a state corresponding to the position of the object relative to the host lane is the first state 501 based on the first area where the object is located relative to the left line being the left area and the second area where the object is located relative to the right line being the left area.

According to an embodiment, in the second state 511, the processor of the object recognition apparatus may determine that the state corresponding to the position of the object relative to the host lane is the second state 511 based on the first area where the object is located relative to the left line being the right area, the second area where the object is located relative to the right line being the left area, and the third area where the object is located relative to the middle line being the left area.

According to an embodiment, in the third state 521, the processor of the object recognition apparatus may determine that the state corresponding to the position of the object relative to the host lane is the third state 521 based on the first area where the object is located relative to the left line being the right area, the second area where the object is located relative to the right line being the left area, and the third area where the object is located relative to the middle line being the right area.

According to an embodiment, in the fourth state 531, the processor of the object recognition apparatus may determine that a state corresponding to the position of the object relative to the host lane is the fourth state 531 based on the first area where the object is located relative to the left line being the right area and the second area where the object is located relative to the right line being the right area.

FIG. 6 illustrates a table showing states corresponding to the position of an object with respect to a host lane in an object recognition apparatus or an object recognition method according to an embodiment of the present disclosure.

Referring to FIG. 6, a first state 601 may indicate that a second reference point based on which the position of an object is determined is located in a left area outside a host lane. A second state 603 may indicate that the second reference point is located in a left area within the host lane. A third state 605 may indicate that the second reference point is located in a right area within the host lane. A fourth state 607 may indicate that the second reference point is located in a right area outside the host lane.

According to an embodiment, the processor of the object recognition apparatus may determine a positional relationship between a specific straight line and the second reference point by substituting the second reference point into a specific function representing the specific straight line.

For example, when the second reference point is located on the specific straight line, a value determined by substituting the longitudinal coordinate of the second reference point into the specific function may be zero.

For example, when the second reference point is located to the left of the specific straight line, the sign of the value determined by substituting the longitudinal coordinate of the second reference point into the specific function may be negative.

For example, when the second reference point is located to the right of the specific straight line, the sign of the value determined by substituting the longitudinal coordinate of the second reference point into the specific function may be positive.

According to an embodiment, in the first state 601, the processor of the object recognition apparatus may determine that the state of the object with respect to the host lane is the first state 601 based on the signs of values determined by substituting the longitudinal coordinate of the second reference point into a first straight line function and a second straight line function being negative. In the first state 601, the sign of a value determined by substituting the longitudinal coordinate of the second reference point into a third straight line function may be negative or positive.

According to an embodiment, in the second state 603, the processor of the object recognition apparatus may determine that the state of the object with respect to the host lane is the second state 603 based on the sign of a value determined by substituting the longitudinal coordinate of the second reference point into the first straight line function being positive and the signs of values determined by substituting the longitudinal coordinate of the second reference point into the second straight line function and the third straight line function being negative.

According to an embodiment, in the third state 605, the processor of the object recognition apparatus may determine that the state of the object with respect to the host lane is the third state 605 based on the signs of values determined by substituting the longitudinal coordinate of the second reference point into the first straight line function and the third straight line function being positive and the sign of a value determined by substituting the longitudinal coordinate of the second reference point into the second straight line function being negative.

According to an embodiment, in the fourth state 607, the processor of the object recognition apparatus may determine that the state of the object with respect to the host lane is the fourth state 607 based on the signs of values determined by substituting the longitudinal coordinate of the second reference point into the first straight line function and the second straight line function being positive. In the fourth state 607, the sign of the value determined by substituting the longitudinal coordinate of the second reference point into the third straight line function may be negative or positive.

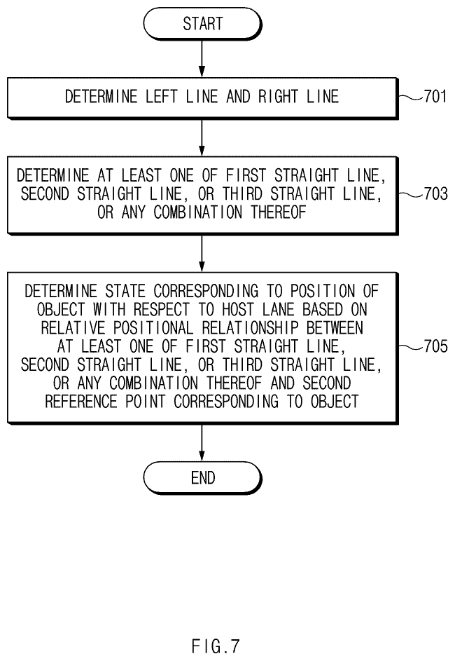

FIG. 7 illustrates a flow chart of operations of an object recognition apparatus for determining a state corresponding to the position of an object with respect to a host lane in an object recognition apparatus or method according to an embodiment of the present disclosure.

Hereinafter, it is assumed that the processor 105 of the object recognition apparatus 101 of FIG. 1 performs the process of FIG. 7. Additionally, in the description of FIG. 7, operations described as being performed by the object recognition apparatus may be understood as being controlled by the processor 105 of the object recognition apparatus 101.

Referring to FIG. 7, in a first operation 701, the processor of the object recognition apparatus may determine a left line and a right line. The left line may be located on the left side of a host lane. The right line may be located on the right side of the host lane. The host lane is a lane where a host vehicle is located and may be a curved path.

In a second operation 703, the processor of the object recognition apparatus may determine at least one of a first straight line, a second straight line, or a third straight line, or any combination thereof. The first straight line may be obtained based on a first reference point included in an object box, which is a virtual box representing an external object, and the left line. The second straight line may be obtained based on the first reference point and the right line. The third straight line may be obtained based on the first straight line and the second straight line and may represent the middle line of the host lane.

In a third operation 705, the processor of the object recognition apparatus may determine a state corresponding to the position of an object with respect to the host lane based on the relative positional relationship between at least one of the first straight line, the second straight line, or the third straight line, or any combination thereof and a second reference point corresponding to the object. The second reference point may be identical to or different from the first reference point.

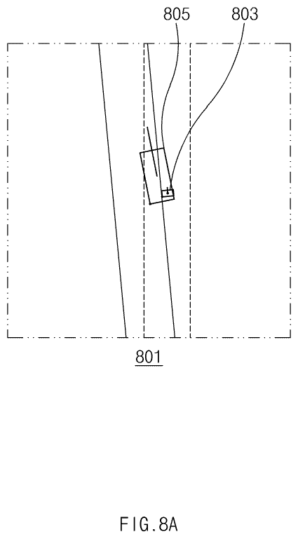

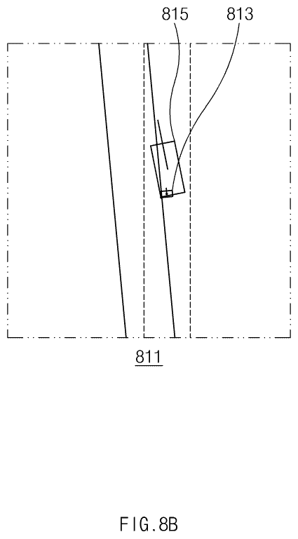

FIG. 8A illustrates an example of state identification according to an existing object recognition apparatus and FIG. 8B illustrates an example of state identification according to an object recognition apparatus in an object recognition apparatus or an object recognition method according to an embodiment of the present disclosure.

Referring to FIG. 8A, in a first situation 801, an existing object recognition apparatus may determine the position of an object. In the first situation 801, a first LIDAR track 803 may represent an object and may be obtained through a LIDAR. A first dynamic object fusion (DOF) track 805 may be obtained by fusing a track representing an object and obtained through a LIDAR sensor with a track obtained through another sensor.

Referring to FIG. 8B, in a second situation 811, an object recognition apparatus according to an embodiment may determine the position of the object. In the second situation 811, a second LIDAR track 813 may represent an object and may be obtained through a LIDAR. A second DOF track 815 may represent an object and may be obtained through a DOF sensor.

In the first situation 801, the existing object recognition apparatus may misrecognize the path of the host lane as a straight path even when the actual path of the host lane is a curved path. Accordingly, the existing object recognition apparatus may incorrectly determine that the position of the first DOF track 805 is inside the host lane. In this case, the position of the nearest collision point of the first LIDAR track 803 and the position of the nearest collision point of the first DOF track 805 may not match each other because a logic for matching nearest collision points does not operate.

In the second situation 811, the object recognition apparatus according to an embodiment may recognize the path of the host lane as a curved path. Accordingly, the object recognition apparatus according to an embodiment may determine the position of the second DOF track 815 to be in a right area outside the host lane. In this case, the position of the nearest collision point of the second LIDAR track 813 and the position of the nearest collision point of the second DOF track 815 may match each other because the logic for matching nearest collision points operates.

The existing object recognition apparatus may determine the position of an object with respect to the host lane, under the assumption that the host lane is a straight path, and then perform an object fusion strategy according to the determined position of the object with respect to the host lane. In this case, when the curvature of the host lane exceeds a reference value, the object fusion strategy to be applied may not be performed.

In the case of an autonomous driving system, because autonomous driving is performed according to the identified position of an object, it may be needed to improve the positional accuracy of the object with respect to the host lane. In particular, because the object fusion strategy is often applied differently depending on the position of the object with respect to the host lane, the object recognition apparatus may improve the accuracy of object recognition by improving the position accuracy of lines with respect to the host lane. The object recognition apparatus according to an embodiment may determine the left line and the right line of the host lane through an N-order function.

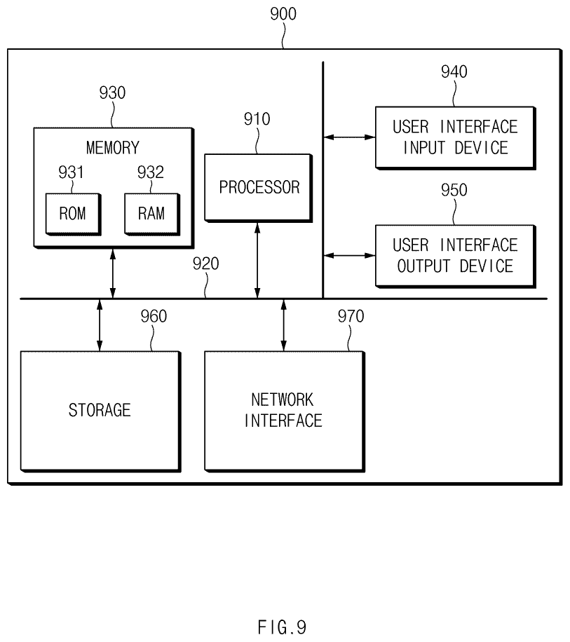

FIG. 9 illustrates a computing system related to an object recognition apparatus and an object recognition method according to an embodiment of the present disclosure.

Referring to FIG. 9, a computing system 900 may include at least one processor 910, a memory 930, a user interface input device 940, a user interface output device 950, a storage (i.e., a memory) 960, and a network interface 970, which are connected with each other via a bus 920.

The processor 910 may be a central processing unit (CPU) or a semiconductor device that processes instructions stored in the memory 930 and/or the storage 960. The memory 930 and the storage 960 may include various types of volatile or non-volatile storage media. For example, the memory 930 may include a ROM (Read Only Memory) 931 and a RAM (Random Access Memory) 932.

Thus, the operations of the method or the algorithm described in connection with the embodiments disclosed herein may be embodied directly in hardware or a software module executed by the processor 910 or in a combination thereof. The software module may reside on a storage medium (that is, the memory 930 and/or the storage 960) such as a RAM, a flash memory, a ROM, an EPROM, an EEPROM, a register, a hard disk, a removable disk, and a CD-ROM.

The exemplary storage medium may be coupled to the processor 910, and the processor 910 may read information out of the storage medium and may record information in the storage medium. Alternatively, the storage medium may be integrated with the processor 910. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of embodiments of the present disclosure, and various modifications and variations may be made without departing from the essential characteristics of the embodiment of the present disclosure by those skilled in the art to which the present disclosure pertains.

Accordingly, the embodiments disclosed in the present disclosure are not intended to limit the technical idea of the embodiment of the present disclosure but to describe exemplary embodiments of the present disclosure, and the scope of the technical idea of the embodiments of the present disclosure is not limited by the embodiments. The scope of protection of the present disclosure should be interpreted by the following claims, and all technical ideas within the scope equivalent thereto should be construed as being included in the scope of the present disclosure.

The present technology may improve the accuracy of the position of an object with respect to a host lane when the host lane is a curved path.

Further, the present technology may improve the accuracy of the position of an object with respect to a host lane at a distance.

Further, the present technology may determine the position of an object via a LIDAR point.

Further, the present technology may reduce the risk of an accident by improving the accuracy of the position of an object with respect to a host lane.

Further, the present technology may improve the convenience of vehicle operation by improving the accuracy of the position of an object with respect to a host lane.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An object recognition apparatus comprising:
a LIDAR;
one or more processors; and
a non-transitory storage storing a program to be executed by the one or more processors, the program including instructions to:
determine a left line located on a left side of a host lane and a right line located on a right side of the host lane, wherein the host lane is a lane where a host vehicle is located and includes a curved path;
determine a first straight line obtained based on a first reference point included in an object box and the left line, a second straight line obtained based on the first reference point and the right line, a third straight line obtained based on the first straight line and the second straight line and representing a middle line of the host lane, or any combination thereof, wherein the object box is a virtual box representing an object that is external to the host vehicle; and
determine a state corresponding to a position of the object with respect to the host lane based on a relative positional relationship between the first straight line, the second straight line, the third straight line, or any combination thereof and a second reference point representing a position of the object box, wherein the second reference point is identical to or different from the first reference point.

2. The object recognition apparatus of claim 1, wherein the program further includes instructions to:
determine a first function representing the left line and a second function representing the right line;
based on the first reference point, the first function, the second function, and a specified distance, determine a first point and a second point located on the left line;
determine a third point and a fourth point located on the right line;
determine a fifth point that is a middle point between the first point and one point among the third point and the fourth point whose longitudinal coordinate matches a longitudinal coordinate of the first point, wherein the fifth point is located on a line segment connecting the first point and the one of the third point and the fourth point whose longitudinal coordinate matches the longitudinal coordinate of the first point;
determine a sixth point that is a middle point between the second point and one point among the third point and the fourth point whose longitudinal coordinate matches a longitudinal coordinate of the second point, wherein the sixth point is located on a line segment connecting the second point and the one of the third point and the fourth point whose longitudinal coordinate matches the longitudinal coordinate of the second point; and
determine the state corresponding to the position of the object with respect to the host lane based on the first straight line connecting the first point and the second point, the second straight line connecting the third point and the fourth point, the third straight line connecting the fifth point and the sixth point, and the second reference point.

3. The object recognition apparatus of claim 2, wherein:
coordinates of the first point include a longitudinal coordinate of the first reference point and a lateral coordinate obtained by substituting the first reference point into the first function;
coordinates of the second point include a longitudinal coordinate of a point spaced apart longitudinally by the specified distance from the coordinate of the first reference point and a lateral coordinate obtained by substituting the longitudinal coordinate of the spaced point into the first function;
coordinates of the third point include the longitudinal coordinate of the first reference point and a lateral coordinate obtained by substituting the first reference point into the second function; and
coordinates of the fourth point include the longitudinal coordinate of the spaced point and a lateral coordinate obtained by substituting the longitudinal coordinate of the spaced point into the second function.

4. The object recognition apparatus of claim 2, wherein the program further includes instructions to determine the first function and the second function in a form of an N-th order function.

5. The object recognition apparatus of claim 2, wherein the program further includes instructions to:
determine the first function, the second function, or the first function and the second function based on a portion of an image identified through a camera; or
determine the first function, the second function, or the first function and the second function based on a yaw rate of the host vehicle, a steering angle sensor angle, or the yaw rate of the host vehicle and the steering angle sensor angle.

6. The object recognition apparatus of claim 1, wherein the program further includes instructions to:
determine a first straight line function, which is a function representing the first straight line, a second straight line function, which is a function representing the second straight line, and a third straight line function, which is a function representing the third straight line;
determine a first area where the object is located among a left area and a right area separated by the left line based on a sign of a value obtained by substituting coordinates of the second reference point into the first straight line function;
determine a second area where the object is located among the left area and the right area separated by the right line based on the sign of the value obtained by substituting the coordinates of the second reference point into the second straight line function;
determine a third area where the object is located among the left area and the right area separated by the middle line based on the sign of the value obtained by substituting the coordinates of the second reference point into the third straight line function; and
determine a state corresponding to the position of the object based on the first area, the second area, the third area, or any combination of the first area, the second area, and the third area.

7. The object recognition apparatus of claim 1, wherein the program further includes instructions to:
determine the state corresponding to the position of the object as a first state based on the second reference point being located in a left area with respect to the left line and the second reference point being located in the left area with respect to the right line;
determine the state corresponding to the position of the object as a second state based on the second reference point being located in a right area with respect to the left line, the second reference point being located in the left area with respect to the right line, and the second reference point being located in the left area with respect to the middle line;
determine the state corresponding to the position of the object as a third state based on the second reference point being located in the right area with respect to the left line, the second reference point being located in the left area with respect to the right line, and the second reference point being located in the right area with respect to the middle line; and
determine the state corresponding to the position of the object as a fourth state based on the second reference point being located in the right area with respect to the left line and the second reference point being located in the right area with respect to the right line.

8. The object recognition apparatus of claim 7, wherein:
the first state indicates that the object is located in the left area outside the host lane;
the second state indicates that the object is located in the left area within the host lane;
the third state indicates that the object is located in the right area within the host lane; and
the fourth state indicates that the object is located in the right area outside the host lane.

9. The object recognition apparatus of claim 1, wherein the program further includes instructions to:
determine the first reference point including a center point of a side closest to the host vehicle among four sides defining the object box; and
determine the second reference point including a center point of the object box.

10. The object recognition apparatus of claim 1, further comprising a camera and a radar, wherein the program further includes instructions to determine the first reference point and the second reference point based on the object identified through the LIDAR, the radar, the camera, or any combination of the LIDAR, the radar, and the camera.

11. An object recognition method comprising:
determining a left line located on a left side of a host lane and a right line located on a right side of the host lane, wherein the host lane is a lane where a host vehicle is located and includes a curved path;
determining a first straight line obtained based on a first reference point included in an object box and the left line, a second straight line obtained based on the first reference point and the right line, a third straight line obtained based on the first straight line and the second straight line and representing a middle line of the host lane, or any combination thereof, wherein the object box is a virtual box representing an object that is external to the host vehicle; and
determining a state corresponding to a position of the object with respect to the host lane based on a relative positional relationship between the first straight line, the second straight line, the third straight line, or any combination thereof and a second reference point representing a position of the object box, wherein the second reference point is identical to or different from the first reference point.

12. The object recognition method of claim 11, wherein:
determining the left line located on the left side of the host lane and the right line located on the right side of the host lane comprises determining a first function representing the left line and a second function representing the right line;
determining the first straight line obtained based on the first reference point included in the object box and the left line, the second straight line obtained based on the first reference point and the right line, the third straight line obtained based on the first straight line and the second straight line and representing the middle line of the host lane, or any combination thereof comprises:
determining a first point and a second point located on the left line based on the first reference point, the first function, the second function, and a specified distance;
determining a third point and a fourth point located on the right line;
determining a fifth point that is a middle point between the first point and one point among the third point and the fourth point whose longitudinal coordinate matches a longitudinal coordinate of the first point, wherein the fifth point is located on a line segment connecting the first point and the one of the third point and the fourth point whose longitudinal coordinate matches the longitudinal coordinate of the first point; and
determining a sixth point that is a middle point between the second point and one point among the third point and the fourth point whose longitudinal coordinate matches a longitudinal coordinate of the second point, wherein the sixth point is located on a line segment connecting the second point and the one of the third point and the fourth point whose longitudinal coordinate matches the longitudinal coordinate of the second point; and
determining the state corresponding to the position of the object with respect to the host lane based on the relative positional relationship between the first straight line, the second straight line, the third straight line, or any combination thereof and the second reference point representing the position of the object box comprises determining the state corresponding to the position of the object with respect to the host lane based on the first straight line connecting the first point and the second point, the second straight line connecting the third point and the fourth point, the third straight line connecting the fifth point and the sixth point, and the second reference point.

13. The object recognition method of claim 12, wherein:
coordinates of the first point include a longitudinal coordinate of the first reference point and a lateral coordinate obtained by substituting the first reference point into the first function;
coordinates of the second point include a longitudinal coordinate of a point spaced apart longitudinally by the specified distance from the coordinate of the first reference point and a lateral coordinate obtained by substituting the longitudinal coordinate of the spaced point into the first function;
coordinates of the third point include the longitudinal coordinate of the first reference point and a lateral coordinate obtained by substituting the first reference point into the second function; and
coordinates of the fourth point include the longitudinal coordinate of the spaced point and a lateral coordinate obtained by substituting the longitudinal coordinate of the spaced point into the second function.

14. The object recognition method of claim 12, wherein determining the left line located on the left side of the host lane and the right line located on the right side of the host lane includes determining the first function and the second function in a form of an N-th order function.

15. The object recognition method of claim 12, wherein determining the first function representing the left line and the second function representing the right line comprises:
determining the first function, the second function, or the first function and the second function based on a portion of an image identified through a camera; or
determining the first function, the second function, or the first function and the second function based on a yaw rate of the host vehicle, a steering angle sensor angle, or the yaw rate of the host vehicle and the steering angle sensor angle.

16. The object recognition method of claim 11, wherein determining the state corresponding to the position of the object with respect to the host lane based on the relative positional relationship between the first straight line, the second straight line, the third straight line, or any combination thereof and the second reference point comprises:
determining a first straight line function, which is a function representing the first straight line, a second straight line function, which is a function representing the second straight line, and a third straight line function, which is a function representing the third straight line;
determining a first area where the object is located among a left area and a right area separated by the left line based on a sign of a value obtained by substituting coordinates of the second reference point into the first straight line function;
determining a second area where the object is located among the left area and the right area separated by the right line based on the sign of the value obtained by substituting the coordinates of the second reference point into the second straight line function;
determining a third area where the object is located among the left area and the right area separated by the middle line based on the sign of the value obtained by substituting the coordinates of the second reference point into the third straight line function; and
determining a state corresponding to the position of the object based on the first area, the second area, the third area, or any combination of the first area, the second area, and the third area.

17. The object recognition method of claim 11, wherein determining the state corresponding to the position of the object with respect to the host lane based on the relative positional relationship between the first straight line, the second straight line, the third straight line, or any combination thereof and the second reference point comprises:
determining the state corresponding to the position of the object as a first state based on the second reference point being located in a left area with respect to the left line and the second reference point being located in a left area with respect to the right line;
determining the state corresponding to the position of the object as a second state based on the second reference point being located in a right area with respect to the left line, the second reference point being located in the left area with respect to the right line, and the second reference point being located in the left area with respect to the middle line;
determining the state corresponding to the position of the object as a third state based on the second reference point being located in the right area with respect to the left line, the second reference point being located in the left area with respect to the right line, and the second reference point being located in the right area with respect to the middle line; and
determining the state corresponding to the position of the object as a fourth state based on the second reference point being located in the right area with respect to the left line and the second reference point being located in the right area with respect to the right line.

18. The object recognition method of claim 17, wherein:
the first state indicates that the object is located in the left area outside the host lane;
the second state indicates that the object is located in the left area within the host lane;
the third state indicates that the object is located in the right area within the host lane; and
the fourth state indicates that the object is located in the right area outside the host lane.

19. The object recognition method of claim 11, further comprising:
determining the first reference point including a center point of a side closest to the host vehicle among four sides defining the object box; and
determining the second reference point including a center point of the object box.

20. The object recognition method of claim 11, further comprising determining the first reference point and the second reference point based on the object identified through a LIDAR, a radar, a camera, or any combination of the LIDAR, the radar, and the camera.
